(19) United States
(12) Patent Application Publication
(10) Pub. No.: US 2001/0010679 A1
(43) Pub. Date: Aug. 2, 2001

(54) DISK DRIVE MOTOR

(76) Inventors: HARUSHIGE OSAWA, KUSATSU-SHI (JP); NAOKI HOROTA, ECHI-GUN (JP)

Correspondence Address: MCCORMICK PAULDING & HUBER, CITYPLACE II, 185 ASYLUM STREET, HARTFORD, CT, 061034102

(21) Appl. No.: 09/219,206

(22) Filed: Dec. 22, 1998

(30) Foreign Application Priority Data
Dec. 29, 1997 (JP) 9-367648

(51) Int. Cl. G11B 23/00

(52) U.S. Cl. 369/266

(57) ABSTRACT

A disk drive motor rotates one or more recording disk carried on a rotor. The rotor is provided with a plurality of annular space so as to be aligned with each other and at least one barrier element is disposed between each of the annular spaces. A plurality of balancing members is accommodated in each of the annular spaces so as to be movable in a circular direction thereof. Because of the balancing device has a plurality of annular paths accommodating a plurality of balancing members, the disk drive motor of the present invention is improved in precision of the correction or counterbalancing for the mass imbalance and correct a large amount of the mass imbalance without increasing the radial and axial dimensions of the motor.

### BACKGROUND OF THE INVENTION

1. Field of the Invention

The present invention relates to a disk drive motor for driving recording disks and, more particularly, to a disk drive motor which is required to operate at high speed with high stability.

2. Description of the Related Art

Various types of recording disks have been proposed and used for the purpose of recording and reproducing of data, such as compact disks (CD), floppy disks (FD), magneto-optical disks (MO), mini-disks (MD), digital video disks (DVD), hard disks (HD), and so forth. Different types of recording disks require different recording/reproducing methods and have different specifications in regard to the size or capacity of stored data, disk driving speed, recording density, and so on, as well as disk materials and prices. Consequently, the disk drive motors having different specifications are used for driving different types of recording disks.

Nowadays, there is a trend towards a higher degree of sophistication and a greater size of electronic data, as image data are handled more than text data. This has given rise to the demand for inexpensive recording disks and disk drives that can quickly store and reproduce large volumes of data.

For instance, CDs were initially used as music recording/playback media but are nowadays applied for spreading use as CD-ROMs which are major storage disks for computers, by virtue of their advantages over other types of media. This type of storage media offers greater storage capacity and shorter operation time, i.e., reduced seek time, permitting much higher speed of rotation by means of high-speed disk drive motors, thus affording disk rotation speeds 20 times as high as that of music CDs.

FIG. 5 shows the construction of an exemplary conventional disk drive motor with a balancing mechanism.

The conventional disk drive motor shown in FIG. 5 has a substantially cylindrical sleeve 3 which at its lower end fixedly fits in an opening 2 formed on a base member 1 which forms a part of a chassis of a disk drive device. The lower opening of the sleeve 3 is closed by a tabular member 4 which carries a thrust member 5. A sleeve bearing 6 made of an oil-impregnated metal or a wear-resistant resin is received in the sleeve 3.

A stator 7 includes a stator core 7a which is secured to the outer surface of the sleeve 3 and stator coils 7b wound around the stator core 7a. A shaft 8 is rotatably supported by the sleeve bearing 6 such that it is in contact at its lower end, with the thrust member 5 while its upper end projects beyond the upper end of the sleeve 3. A rotor hub 9 made of non-magnetic material such as aluminum is fixed to the upper end of the shaft 8. A yoke 10 made of magnetic material such as iron is fixed to the rotor hub 9.

The yoke 10 has a disk-shaped base portion and a cylindrical portion which is integrally formed with the base portion and extends downward from the radially outer end of the base portion. The inner peripheral edge defining an opening formed at the central portion of the base portion is fixed to a lower end portion of the rotor hub 9 by calking. An annular rotor magnet 12 is fixed to the inner peripheral surface of the cylindrical portion of the yoke 10 so as to radially face the stator 7.

As shown in FIG. 5, the turntable 13 is formed on the outside of the rotor hub 9. A clamp magnet 14 is embedded on the rotor hub 9 at its central portion such that the clamp magnet 14 is substantially flush with the top surface of the rotor hub 9. The clamp magnet 14 magnetically attracts a disk pressing means (not shown) formed on the disk drive unit side in order to fixedly carry a recording disk D thereon. When current is supplied to the coils 7b of the stator 7, a magnetic force is generated between the stator 7 and the rotor magnet 11 to induce a torque in the motor and then the rotor magnet 11, the yoke 10, the rotor hub 9 and the shaft 8 start to rotate relatively with the stator 7 which works as the stationary member whereby the turntable 13 and the recording disk D rotate in a predetermined direction.

When such a motor rotates at a high speed, new problems are arose. For example, in the case the motor is used drive a compact disk-read only memory (CD-ROM), the CD-ROM has a printed title or picture or other various types of prints on its non-recording surface. Many of the prints of the disk are not always distributed uniformly and the mass of the disk is partially made difference. Therefore, the mass imbalance is caused on the rotary member. The mass imbalance caused by the prints is a bit, however, a bit of the mass imbalance gives birth to run-out of the motor as the motor is driven at high speed. Similar kinds of problems occur with other types of recording disks.

The balancing device as shown in FIG. 5 may be used for overcoming the problems as stated above. The balancing device shown in FIG. 5 is constituted by; an annular groove formed on the lower portion of the turntable 13 to open downwardly; the top surface of the yoke 10 covering the opening of the annular groove such that the annular space serving as an accommodating portion 16 is formed coaxially with the rotational axis of the motor; and a plurality of steel balls serving as a balancing member movably accommodated within the accommodating portion 16. In such the balancing device, when the motor speed is at low, the steel balls 17 are positioned randomly in the accommodating portion 16. When the rotational speed of the motor exceeds a predetermined rotational speed, the steel balls 17 are moved to the outer peripheral portion of the accommodating portion 16 and are positioned at equal intervals due to the effect of centrifugal force. In case of imbalance occurs during the rotation, the steel balls 17 are temporarily gathered at a portion of the accommodating portion 16 where the mass imbalance is taking place. However, when the motor speed exceeds value at which the resonance takes place due to coincidence between the frequency of the vibration of the steel balls 17 and the natural frequency of the motor, the steel balls 17 are moved to a position symmetrical with the point of the mass imbalance to eliminate the mass imbalance, thereby reducing the run-out.

However, with the conventional balancing device as shown in FIG. 5, the amount of correction and the precision of correction for mass imbalance is limited. This is because, the amount of correction for mass imbalance of the balancing device depends on the number and mass of steel balls 17, and the radius of the annular path in which the steel balls 17 can move.

On the other hands, the amount of correction for mass imbalance may be increased by, for example, increasing the cross-sectional area of the accommodating portion and increasing the diameter of the steel balls 17, accommodating a larger number of steel balls 17 in the accommodating portion or increasing the diameter of the accommodating portion so as to increase the range in which the steel balls 17 can move. However, in order to improve the precision of correction for mass imbalance, the diameter of the steel balls 17 must be made small, which contradict with the requirement of increasing the amount of correction for mass imbalance as described above.

As disk drive device for compact apparatus such as notebook personal computers having a CD-ROM drive device are required to use a small and thin motor, the accommodating portion 16 of the balancing device for such motors must be made flat and have a small volume, making it necessary to use small diameter of the steel balls 17 accommodated in the accommodating portion 16. The steel balls 17 having a small diameter rise the problem that when the amount of mass imbalance of the disk D becomes greater than a predetermined amount, the balancing device can not correct the mass imbalance sufficiently.

### SUMMARY OF THE INVENTION

Accordingly, it is an object of the present invention to provide a disk drive motor which enables sufficient amount of correction or counter-balancing for mass imbalance without reducing rotational precision at a high speed.

It is another object of the present invention to provide a small and thin disk drive motor with a highly reliable balancing device.

It is still another object of the present invention to provide a disk drive motor capable of counter-balancing a large amount of imbalance.

The disk drive motor of the present invention comprises a balancing device including a plurality of annular paths formed concentrically with the rotor, and a plurality of balancing members which are accommodated in the annular paths so as to be movable in a circular direction thereof. A partition is provided between adjoining annular paths to prevent the balancing members from moving from one to other paths.

Compared to the conventional balancing device having only one path, the disk drive motor of the present invention having a plurality of paths in the balancing device is improved in precision of correction or counterbalancing for the mass imbalance, enabling sufficient amount of correction for the mass imbalance. It is to be noted that the paths may be constructed either by forming a recess on the rotor and dividing the recess into two or more sections by a partition formed therebetween such that the balancing members accommodated in the certain path are prevented from moving into a different paths or by forming a plurality of grooves on the rotor.

The annular paths may be arranged concentrically in radial direction, or be arranged in the direction of the rotational axis of the motor such that a plurality of paths are formed without increasing the radial and axial dimensions of the disk drive motor.

The balancing members accommodated in the paths may be designed suitably for their purpose, determination being made regarding outside dimensions, the mass, the specific gravity, the hardness, the material and/or the method of surface treatment.

The larger the mass of the balancing members is, the more the mass imbalance is corrected. Therefore, the amount of correctable mass imbalance is easily increased by suitably selecting the diameter, mass and/or specific gravity of the balancing members in accordance with the size of the paths that is allowed to be selected in consideration of the dimension of the motor. Noise generated by collision of the balancing members against the walls of the paths may be reduced if the balancing members is formed by a soft material in correspondence with the hardness of the contact surface of the paths or the hardness of the surface of the balancing members is changed. Further, the mass imbalance may be corrected or counterbalanced more precisely if balancing members having a small mass or specific gravity are accommodated in the paths formed on the radially inward portion of the motor while balancing members having large mass or specific gravity are accommodated in the paths formed on the radially outward portion of the motor.

The foregoing, together with other objects, features and advantages of this invention, can be better appreciated with reference to the following description, claims, and the accompanying drawings.

### BRIEF DESCRIPTION OF THE DRAWINGS

FIG. 1 illustrates a graph showing the relationship between the diameter of spherical members as balancing members and the amount of the correctable mass imbalance for different diameter paths.

FIG. 2(a) is a table showing the relationship between the number of paths and path diameter.

FIG. 2(b) is a graph showing the relationship between the number of paths and the amount of correctable mass imbalance.

FIG. 3(a) is a vertical cross-sectional view of a first embodiment of the disk drive motor in accordance with the present invention.

FIG. 3(b) is a plan view of the first embodiment of the disk drive motor in accordance with the present invention.

FIG. 4 is a vertical cross-sectional view of a second embodiment of the disk drive motor in accordance with the present invention.

FIG. 5 is a vertical cross-sectional view of a conventional disk drive motor.

### DETAILED DESCRIPTION OF THE PREFERRED EMBODIMENTS

(Explanation of Principles of Balancing Device)

A description will now be given of the principles of a balancing device used in the disk drive motor of the present invention.

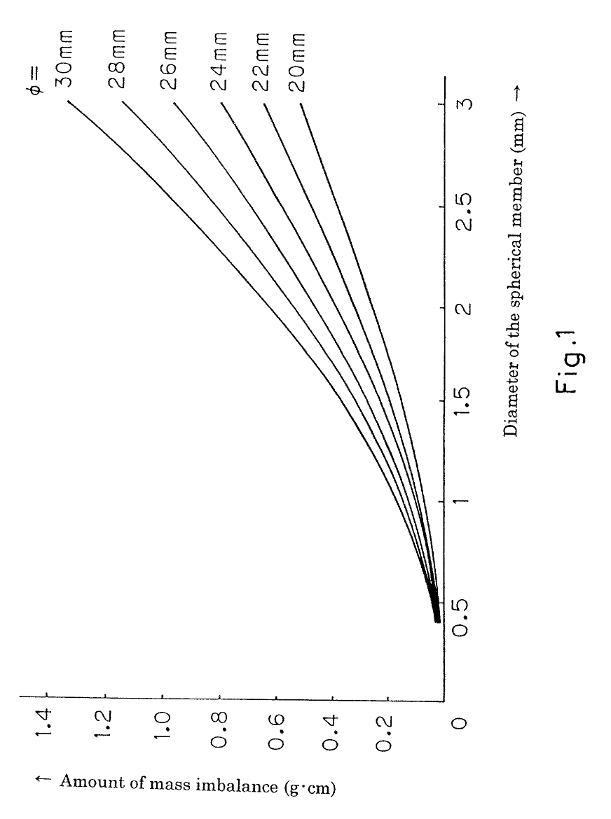

FIG. 1 illustrates a graph showing the relationship between the diameter of a plurality of spherical members or balls as balancing members accommodated in annular paths formed on a rotor and and the correctable amount of mass imbalance (maximum value) with the diameter (φ) of the outer wall of the path being selected at 20-mm, 22-mm, 24-mm, 26-mm, 28-mm and 30-mm.

From the graph of FIG. 1, it can be understood that:

(i) The larger the diameter (φ) of the path is, the more the correctable amount of mass imbalance is, and

(ii) Even when the diameter (φ) of the path is the same, the larger the diameter of the spherical members is, the more the correctable amount of mass imbalance is.

In other words, when the diameter (φ) of the path and the diameter of the spherical members accommodated in the path are made as large as possible, the correctable amount of mass imbalance is the largest. It is to be noted that the correctable amount of mass imbalance is expressed by the product of the mass of the balancing member and the distance from the rotational center to the center of gravity of the rotating member (including the balancing members).

When the rotor having the amount of mass imbalance indicated on the vertical axis of FIG. 1 rotates at a speed above the resonance speed, the balancing device operates so as to counterbalance or offset the mass imbalance and the location of the center of gravity of the rotor changes thereby eliminating the mass imbalance of the rotor and reducing centrifugal force caused by the mass imbalance. Since the centrifugal force is equal to the product of the total amount of imbalance and the square of the angular velocity (or using symbols F_{ω}=Uω², where F_{ω}=centrifugal force, U=amount of imbalance, and ω=angular velocity), it can be said that the higher rotational speed becomes, the more the amount of imbalance becomes of serious problem. However, the diameter (φ) of the paths and the spherical members have to be limited within specific values in view of the size of the motor which is required to be is small and thin.

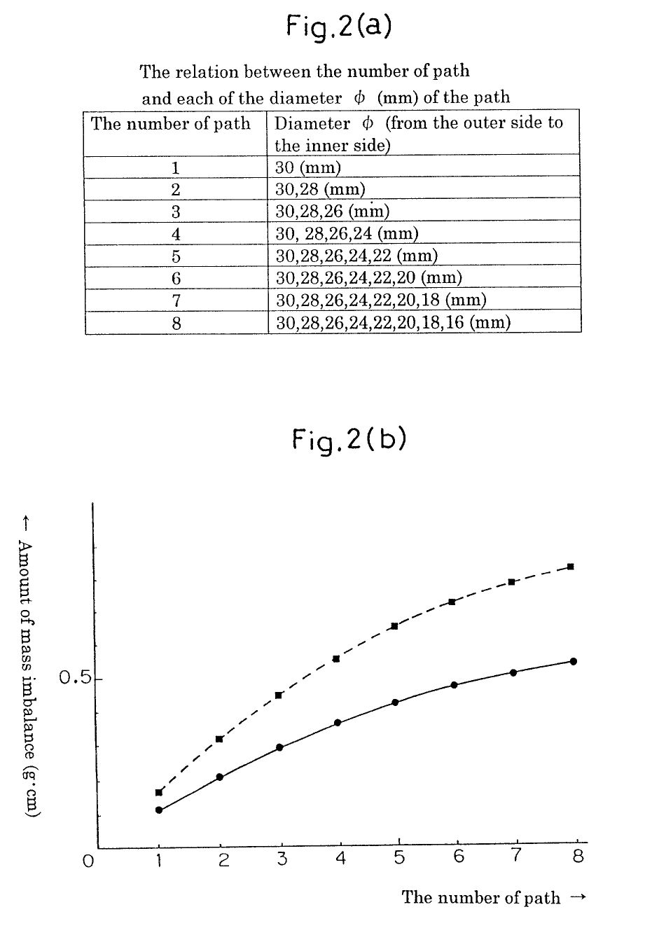

FIG. 2(a) illustrates a table showing the relationship between the number of paths and the diameters of the each of the paths. FIG. 2(b) illustrates a graph showing the relationship between the number of annular paths indicated on the horizontal axis and the correctable amount of mass imbalance indicated on the vertical axis. In FIG. 2(b) , the solid line indicates the relationship between the number of annular paths and the correctable amount of mass imbalance by using the spherical members made of stainless steel (SUS) so as to have 0.8-mm in diameter with 7.8 g/cm³ in specific gravity, and the broken line indicates the relationship between the number of annular paths and the correctable amount of mass imbalance where spherical members or balls as the balancing members are made of stainless steel (SUS) and have 1.0-mm diameter with 7.8 g/cm³ in specific gravity. In both cases, the spherical members or balls are disposed in the paths with the number of spherical members being selected such that the spherical members occupy the semicircle of the paths when the spherical members are lined closely side by side. In this case, the table of FIG. 2(a) and the graph of FIG. 2(b) shows a relationship between the number of paths and the diameters of the outer walls of the paths with the assumption that the largest diameter is 30 mm and number of the paths and the diameter of each the spherical member or ball is 1 mm or less. It is to be noted dimensions of the diameters of the paths and dimension of the spherical member may be determined in accordance with their design purpose.

As shown in FIG. 2(a) , when the number of path is one (1) , the diameter (φ) of the path is 30 mm, and when the number of path is two (2), the diameter (φ) of the path positioned in the outer peripheral side is 30 mm and the diameter (φ) of the path positioned in the inner peripheral side is 28 mm. When more than two paths are used, the diameter (φ) of each of the path decreases progressively from the outer peripheral side to the inner peripheral side by 2 mm.

The graph as shown in FIG. 2(b) seems that even when the diameters of the spherical members are the same, the number of paths can be larger and the amount of correctable mass imbalance also can be large. In addition, even when the number of path is the same, the diameters of the spherical members can be large and the correctable amount of mass imbalance also can be large.

Basing on the results shown in FIG. 1 and FIGS. 2(a) and 2(b), the present invention relates to the balancing device having a plurality of paths so as to increase the amount of correctable mass imbalance and to achieve more precise of corrections none the less the limitation that the motor is small and thin.

(First Embodiment)

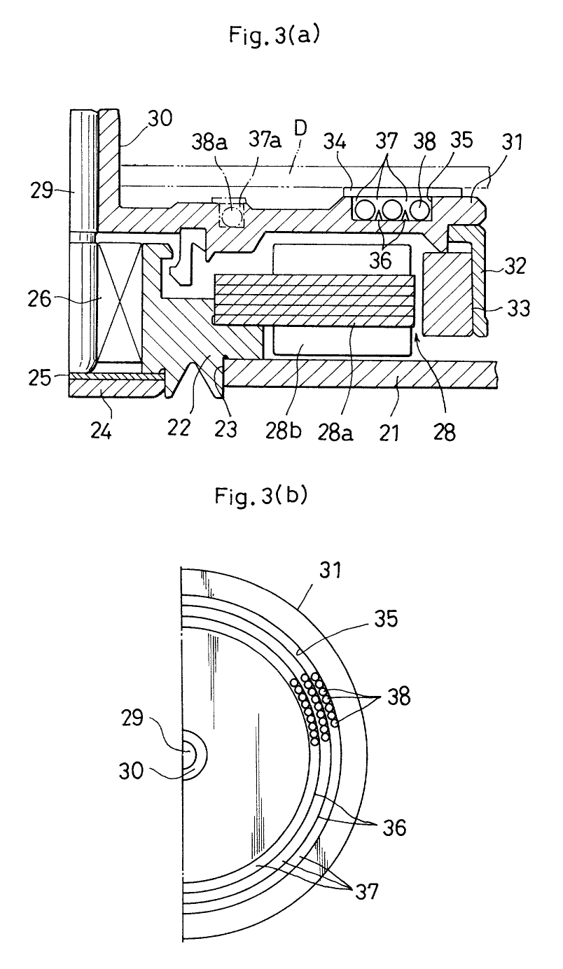

A description will now be given of the first embodiment of the present invention with specific reference to FIGS. 3(a) and 3(b). FIG. 3(a) is a partial sectional view of the first embodiment of the disk drive motor in accordance with the present invention and FIG. 3(b) is a plan view of the first embodiment of the disk drive motor in accordance with the present invention. In the description of the embodiment, a CD-ROM drive motor is used as the disk drive motor.

With reference to FIG. 3(a), a disk drive motor of the first embodiment has a stationary member 21 which forms a part of a chassis of disk driving device and a stationary cylindrical sleeve member 22 which is secured at its lower end to the brim of an opening 23 formed in the stationary member 21. A circular plate member 24 is fixedly secured to the bottom of the sleeve member 22 to close its opening. A thrust member 25 is fixed to the upper surface of the circular plate member 24 so as to be positioned at the bottom of the sleeve member 22. A sleeve bearing 26 made of an oil-impregnated metal or a wear-resistant resin, is secured to the inner peripheral surface of the sleeve member 22.

The disk drive motor further has a shaft 29 and a stator 28 which includes a stator core 28a fixed to the outer surface of the sleeve member 22 and coils 28b wound around the stator core 28a. The lower part of the shaft 29 is supported within the sleeve bearing 26 and is in contact with the thrust member 25. The upper end of the shaft 29 projects beyond the upper end of the sleeve member 22. The shaft 29 which serves as a part of rotary member is rotatably supported by the sleeve bearing 26. A rotor hub 30 made of a non-magnetic material such as aluminum is fixed to the upper end of the shaft 29 and also serves as a part of the rotary member. A turntable 31 is integrally formed with the rotor hub 30 at the radially outside portion of the rotor hub 30.

A yoke 32 is made of magnetic material such as iron and has a ring-shaped base portion and a cylindrical portion integrally formed with the base portion and extending downward from the radially outer end thereof. The base portion is secured to an annular projection which is formed on a lower end portion of the turntable 31. A rotor magnet 33 is fixedly secured to the inner peripheral surface of the cylindrical portion of the yoke 32 so as to oppose the stator 28. A recording disk D such as a CD-ROM is mounted on the upper surface of the turntable 31 through an intermediary buffer member 34.

In FIGS. 3(a) and 3(b), reference numeral 35 denotes an annular recess formed on the top surface of the turntable 30. The annular recess 35 is formed concentrically with the turntable 31 which in turn serves as a rotating member with its open top being closed by the buffer 34. Reference numeral 36 denotes a plurality of annular projections formed concentrically with the rotational axis of the motor and integrally formed with the bottom surface of the annular recess 35. Reference numeral 37 denotes a plurality of annular paths formed by dividing the annular recess 35 into sections by the annular projections 36, while reference numeral 38 denotes spherical members serving as balancing members and accommodated in the paths 37. A plural number of the spherical members 38 are accommodated in the each of path 37. The spherical members 38 are, for example, steel balls. The annular recess 35, the annular projections 36 and the spherical members 38 comprise a balancing device which corrects or counterbalance any mass imbalance by the movement of the spherical members 38 in the paths 37 as shown in FIG. 3(b).

In FIG. 3(a), the height of each of the annular projections 36 is about half of the depth of the annular recess 35, however, the height of each of the annular projections 36 may be the same as or slightly smaller than the depth of the annular recess 35. The annular projections 36 are formed in the annular recess 35 to prevent spherical members 38 in a path 37 from moving into other path 37. The contact surface between the annular recess 35 and the spherical members 38 must be sufficiently smooth and have no deformation. The spherical members 38 are formed such that their diameters are slightly smaller than the axial and radial dimensions of the paths 37, whereby the spherical members 38 are allowed to move smoothly in the paths 37 in a circular direction thereof. It is desirable that the spherical members 38 are disposed in the paths 37 with the number of spherical members 38 being selected such that the spherical members 38 occupy the semicircle of the paths 37 when the spherical members 38 are lined closely side by side.

A description will now be given of the operation of the motor of the present embodiment when the recording disk D is placed on the turntable 30.

Let's assume that the motor is subject to a mass imbalance due to, for example, various types of prints on the surface of the recording disk D. After the motor starts to rotate, each of the spherical member 38 tends to move within the paths 37 along the line extending from the line passing through the center of rotation and the center of gravity of the recording disk D, until the motor speed exceeds a resonance speed at which resonance takes place due to coincidence between the frequency generated by the rotation of the motor and the natural frequency of the motor which includes the recording disk D placed on the turntable 31, thereby increasing the amount of vibration even more. As a result, the motor rotates in imbalanced condition.

When the motor with the recording disk D placed on the turntable 31 rotates at a speed beyond the resonance speed, the spherical members 38 accommodated in the paths 37 are moved to a position where the mass imbalance is eliminated with respect to the center of rotation. Here, the amount of mass imbalance of the rotating member including the recording disk D becomes zero, so that undesired centrifugal force does not act on the center of rotation of the motor. As a result, the center of rotation, the centerline of the shaft 29 and the center of gravity of the motor are aligned and the rotating member rotates stably.

When the motor is rotating normally in a balanced condition, regardless of the presence of various types of prints or the like on the surface of the recording disk D, the spherical members 38 similarly gather to a certain location from the time when the motor to rotate until the motor speed exceeds the resonance speed at which resonance takes place due to the coincidence between the frequency produced by rotation of the motor and the natural frequency of the motor thereby increasing the amount of vibration and the motor rotates in an unstable rotation. However, when the motor speed exceeds the resonance speed, the spherical members 38 are moved so as to be positioned substantially at equal intervals in the paths 37. Accordingly, even when there is no mass imbalance on the rotating member, the spherical members 38 are positioned in the paths 37 so as not to interfere with the balanced rotation of the motor. As a result, the motor rotates stably.

According to the first embodiment of the present invention, a plurality of spherical members 38 is accommodated in a plurality of paths 37 under the condition that the motor is required to have a small and thin configuration. Therefore, compared to the conventional balancing device having a single path as shown in FIG. 5, the balancing device of the present invention can correct or counterbalance a large amount of mass imbalance. In addition, the balancing device of the present invention can corrects the mass imbalance in accordance with the amount of mass imbalance of each disk none the less the recording disk D mounted on the motor is a removable type recording disk (such as a CD-ROM) and each of the recording disk has different types of prints or the like on the surface and a different amount of mass imbalance, so as not to interfere the balanced rotation of the motor.

An annular recess 35 is formed on the top of the turntable 31 and is divided into sections by annular projections 36 thereby forming paths 37 having different diameters in a plane. Therefore, the motor can maintain the size in small and thin without increasing the radius or axial height of the motor.

Further, referring to the graph of FIG. 2(b), as the number of paths 37 become large, the correctable amount of mass imbalance also becomes large and the precision of the correction for the mass imbalance is improved. Therefore, as indicated by the chain line in FIG. 3(a), one or more small path 37a having small diameter may be formed, for example, in the vicinity of the central portion of the top surface of the turntable 31 and concentrically with the paths 37 and a plurality of spherical members 38a may be accommodated in the path or paths 37a. In addition, a large diameter path may be formed closer to the outer peripheral edge than the paths 37 in the turntable 31, making it possible to further increase the amount of mass imbalance can be corrected.

The paths 37 may be formed by a plurality of annular recesses having small width and formed on the top surface of the turntable 31. And the spherical members 38 may be changed the diameters such that each of the paths 37 accommodates the spherical members 38 having different diameters.

(Embodiment 2)

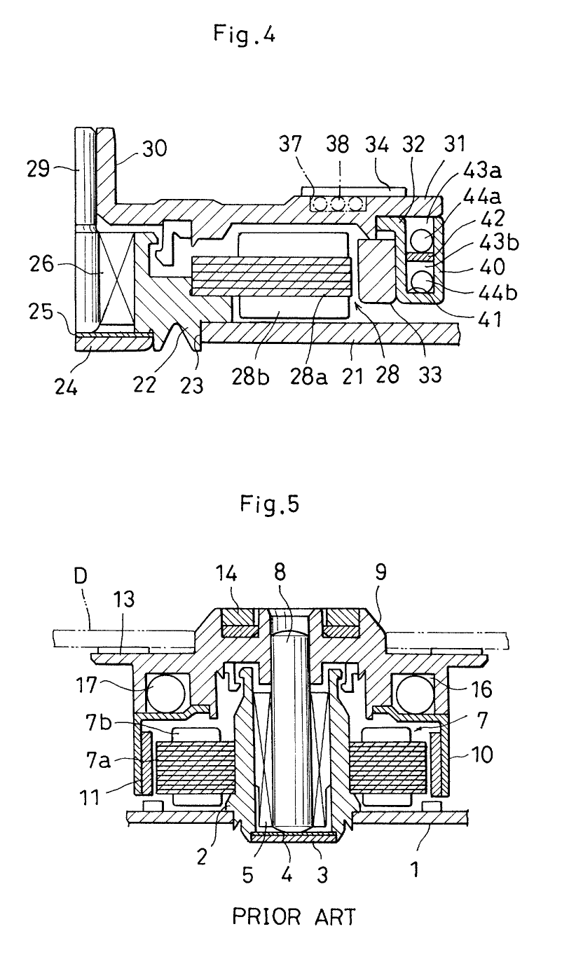

A description will now be given of a second embodiment of the present invention with reference to FIG. 4. In this Figure, the same reference numerals as those used in FIG. 1, illustrating the first embodiment, are employed to denote parts or components of the second embodiment which are the same or equivalent to those of the first embodiment. Accordingly, a description of such same or equivalent parts will not be given below.

In the present embodiment, as shown in FIG. 4, the depending portion of the yoke 32 is bent into a substantially U shape to form a bent portion 40 and an annular groove 41 is formed between the depending portion of the yoke 32 and the outer peripheral wall of the bent portion 40. The annular groove 41 has substantially the same thickness and width as the thickness of a rotor magnet 33.

The top of the annular groove 41 is open and the bottom surface of a turntable 31 closes the opening of the annular groove 41. The annular groove 41 is divided in the axial direction by a ring-shaped member disposed on axially central portion of the annular groove 41 whereby two annular paths 43a and 43b having the same width are formed so as to be aligned in the axial direction within the yoke 32 which serves as the rotating member. A plurality of spherical members 44a and 44b serving as balancing members with the same diameter are accommodated in each of the paths 43a and 43b.

As in the first embodiment, the diameters of the spherical members 44a and 44b are smaller than the axial and radial dimensions of the paths 43a and 43b so as to allow the spherical members 44a and 44b to move in the paths 43a and 44b in a circular direction thereof.

By virtue of the above-described construction, when the recording disk is mounted on the motor and the motor speed exceeds the resonance speed of the motor, mass imbalance is corrected or counterbalanced a large amount, same as in the first embodiment. The balancing device of the present embodiment can correct large amount of the mass imbalance by using the spherical members 44a and 44b accommodated in each of the paths 43a and 43b.

Accordingly, in the second embodiment, since paths 43a and 44b are formed at the radially outer side of the depending portion of the yoke 32, the turntable 31 can be made thin and a large amount of mass imbalance can be precisely corrected without increasing the radius or axial height of the motor.

Because of the paths 43a and 43b are formed on the radially outer side of the yoke 32 so as to be aligned in the axial direction, the dimensions of diameters and widths of the paths 43a and 43b may be selected from wide range. Therefore, compared to the first embodiment, the diameters of the paths 43a and 43b can be made large and the spherical members 44a and 44b having large diameters may be used thereby larger amount of mass imbalance can be corrected.

As indicated by the chain line, a plurality of paths 37 as used in the first embodiment may be formed on the top surface of the turntable 31 and a plurality of spherical members 38 are accommodated in the paths 37, so that the amount of mass imbalance can be more precisely corrected.

In addition, each of the paths 43a and 43b may accommodate the spherical members 44a and 44b accommodated therein have different diameter with each other. For example, the spherical members 44b accommodated in the axially lower side path 43b may be formed so as to have larger diameter than the diameter of the spherical member 44a accommodated in the axially upper side path 43a.

In the above-described embodiments, the spherical members 38, 44a, and 44b are made by steel, however, heavy metal with a high specific gravity such as zinc or tungsten may also be used. By using heavy metal with a high specific gravity for the balancing members, large amount of centrifugal force acts on the balancing members thereby larger amount of mass imbalance can be corrected.

In consideration of the durability of the balancing member and environment in which the motor is used and in order to increase the precision of correction for the mass imbalance, a non-metal material having a low specific gravity such as ceramic, rubber or plastic may also be used for the spherical members 38, 44a and 44b as a substitute of metals.

The spherical members 38, 44a and 44b made of metal are coated the surface by soft material such as resin so the spherical materials 38, 44a and 44b have a double structure or the spherical materials 38, 44a and 44b are made of rubber thereby noise due to collision between each of the spherical member 38, 44a and 44b is reduced. Therefore, the motor can reduce the generation of noise.

In the above-described embodiments, the spherical members 38, 44a and 44b are used as balancing members, however, other types of balancing members such as rolling members may also be used. Rolling elements, fluids or semi-fluids such as liquid may be used as balancing masses. In short, the balancing device can obtain substantially similar effect with above described embodiments for correcting the mass imbalance without using the spherical members as the balancing member so long as the balancing members are constructed such that the balancing members accommodated in a certain path are limited to move into an adjacent path and the balancing members are allowed to move in their respective paths in the circular direction thereof. In addition, the balancing device can prevent the noise caused by the collision between each of the spherical member from generating by using fluids or semi-fluids as the balancing masses.

The size and number of spherical members 38, 44a and 44b and the diameter and number of paths 37, 43a and 43b are not limited to those given in the above-described embodiments so that the size and number may be appropriately selected in consideration of the configuration of the motor and the amount of mass imbalance. The precision of correction or counterbalancing for the mass imbalance can be improved by, for example, disposing the spherical members with smaller mass in an inner peripheral side path and disposing the spherical members with larger mass in an outer peripheral side path or by using both spherical members and fluid as the balancing masses and disposing them in each of the path.

In the above-described embodiments, a disk drive motor having a shaft 29 that rotates was taken as an example. However, other types of motors may also be used such as an inner rotor type motor or a motor having a stationary shaft.

Further, in the above-described embodiments, a CD-ROM drive motor was used as the disk drive motor. However, other types of motors for driving removable type disks such as compact disks, floppy disks, magneto-optical disks, mini-disks or digital video disks or for driving hard disks may also be used.

Although the invention has been described in terms of practical embodiments, it is to be understood that the described embodiments are only illustrative, and various modifications and changes may be imparted without departing from the spirit and scope of the present invention: What is claimed is:

1. A disk drive motor comprising:
a stationary member;
a rotor supported by a bearing member so as to be relatively rotatable with the stationary member, one or more data storage disk being mounted on the rotor;
a stator disposed on the stationary member and a rotor magnet attached to the rotor so as to oppose the stator;
the rotor being provided with a plurality of annular spaces arranged so as to be parallel with each other;
a plurality of balancing members accommodated within adjoining annular spaces so that the balancing members are movable in the circular direction thereof; and
at least one barrier element disposed between each of the annular spaces whereby the balancing members are prevented from moving from one annular space to other annular spaces.

2. A disk drive motor according to claim 1, wherein each of the annular spaces has a different diameter and are aligned in radial direction.

3. A disk drive motor according to claim 1, wherein the annular spaces are separated in the axial direction by the barrier element such that each of the annular spaces have a same diameter.

4. A disk drive motor according to claim 1 wherein the annular spaces are separated in the axial direction by the barrier element such that each of the annular spaces have different diameters.

5. A disk drive motor according to claim 1, wherein the balancing members are formed by a plurality of spherical members.

6. A disk drive motor according to claim 1, wherein the barrier element is integrally formed with the rotor.

7. A disk drive motor comprising:
a base member having a cylindrical member;
a shaft rotatably supported within the cylindrical member through a bearing member;
a turntable fixed to one end portion of the shaft and having an annular projection formed on a lower surface of the turntable;
a yoke member having a disk shaped portion and a cylindrical portion depending from an outer edge of the disk shaped portion, the disk shaped portion being provided with a central opening and an inner edge of the disk shaped portion fixed to the annular projection;
a rotor magnet attached to the inner peripheral surface of the cylindrical portion of the yoke member; and
a stator disposed on the base member so as to oppose to the rotor magnet;
wherein, the shaft, the turntable, the yoke member and the rotor magnet constitute a rotor, the rotor is provided with a plurality of annular spaces, each of the annular spaces accommodate a plurality of balancing members so as to be moveable in a circular direction thereof;
wherein, the annular spaces are divided by at least one barrier element such that the balancing members accommodated in one of the annular spaces are limited to move to other annular spaces.

8. A disk drive motor according to claim 7, wherein the annular spaces are disposed on the turntable so as to be parallel in the radial direction.

9. A disk drive motor according to claim 8, wherein the upper surface of the turntable is provided with an annular groove, the barrier element is disposed within the annular groove and the annular groove is covered by a sealing member so as to form the annular spaces.

10. A disk drive motor according to claim 8, wherein the upper surface of the turntable is provided with a plurality of annular grooves, the barrier element is integrally formed with the turntable and is disposed between the each of the annular grooves and the annular grooves are covered by a sealing member so as to form the annular spaces.

11. A disk drive motor according to claim 7, wherein the cylindrical portion has an inner peripheral wall, an outer peripheral wall and a bottom wall connecting the lower end portion of the inner and the outer peripheral wall, an annular bore is formed between an inner peripheral wall and an outer peripheral wall and the bottom wall and the top of the bore is covered by the lower surface of the turntable.

12. A disk drive motor according to claim 11 wherein the annular bore is separated in the axial direction by the barrier element so as to form the annular spaces which are aligned in the axial direction.

13. A disk drive motor according to claim 12, wherein the barrier element is disposed in the vicinity of the axially central portion of the annular bore, the annular bore is separated by the barrier element so as to form upper and lower annular spaces and the upper and the lower annular spaces have different diameters with each other.

14. A disk drive motor according to claim 7, wherein the balancing members are formed by a plurality of spherical members.
